(19) United States
(12) Patent Application Publication
(10) Pub. No.: US 2008/0072835 A1
(43) Pub. Date: Mar. 27, 2008

(54) Combined pot and aquarium

(76) Inventor: Charoenchai Hongtawornsiri, Bangkok (TH)

Correspondence Address: Mr. Naroon Sooksmam, 264 Soi Phaholyothin 24 Ladyao Chatuchak, Bangkok, 10900, omitted

(21) Appl. No.: 11/699,110

(22) Filed: Jan. 30, 2007

(30) Foreign Application Priority Data
Sep. 12, 2006 (TH) 0603001222

(51) Int. Cl. A01K 63/00

(52) U.S. Cl. 119/246

(57) ABSTRACT

The container for fish and pot plant is a design to bring together the combination function of both pot plant container and fish bowl. It could be used for decoration purpose in place of small pots and vases for beauty, space economy, and ease of maintenance. The soil container for plant is placed above whereas the water container used for fish or water plant is place below. The plant will receive water and nutrition from water used for fish in the lower container which has three designs, which are (1) Using rope as a water absorber, (2) Using a hand pump to suck water in or (3) Using an electrical pump to pull water in. Fishes living the lower section also serve another purpose on eradicating mosquito larvas from mosquitoes which always laid their eggs in water reservoir which is likely to found its occurrences in the supporting base of plant pots and water filled in flower vases.

### BACKGROUND OF THE INVENTION

1. Field of the Invention

This invention is about plant pot that has space below for which can contain water for fish keeping. The plant or flower will get food nurishment and water from the fish keeping activity below. Small fishes are most suitable for this kind of container. Especaily betta fish that can breathe in oxygen from water surface.

2. Description of Related Art

Growning plants and keeping fishes in comfort of our home has become one of the most popular hobby of people everywhere for sometimes. This activities give people amusement and at the sametime can provide them with great decorating object for their home. In today society, many people live in small houses or comdominium in middle of big cities. Time and space for growing plant and keeping fishes as hobby have become more scare for them. From the above difficully, the idea of combining plant growing and fish keeping together to save time and space arise. For this invention the plant above the container will recive water and nutrition from the water below that used in keeping fishes. Fishes below will get rid of mosquito larvas which normally happen with still water source such as in a flower vase or base of a plant pot. Moreovre, this invention gives new decorating idea to your home as a replacement for plant pot and vase

### SUMMARY OF THE INVENTION

Objective of this invention is to combine plant growing and fish keeping together for new decorating idea and at the same time saving space and time. This invention has speacial character which is that it comprises of an outer part that can be filled with water for fish keeping activity and an inner part that can be filled with soil for plant growing activity hiden inside. This invention should have at least one opening at the back, side or top for ventilation and feeding purposes. The plants above in the pot will get nurishment and moisture from the water in the fish tank below in 3 ways that are: (1) Through a rope or moisture absorbent material (2) A hand-pump instrument and (3) An electric water-pump which has a control valve controls the flow rate of water to the plant pot.

One more benefit, fishes living the lower section eradicate mosquito larvas which mosquitoes always laid their eggs in water filled in the supporting base of plant pots and flower vases.

### DETAILED DESCRIPTION OF THE PREFERRED EMBODIMEN

FIG. 1 shows an invention for a container that could be used for either purpose, as plant pot and as fish bowl 1. The outer container component used for water containing for fish 2. There is at least one transparent side to allow a vision of fishes inside and there is inner container for pot plant 3 fitting hidden inside. The container has at least one opening at the back or at side to enable air circulation and use for fish feeding. A different design may be used making a concave shaping of an inner container used for pot plant, makes it an air circulation opening and use it for a feeding slot from the top of the container.

An outer fish container 2 is made of materials such as mortar, baked clay or ceramics which has a lower section for water container. This component must have at least one part made of glass, transparent plastic or the likes, to enable fish viewing. All part of the container will be made from transparent materials with the same class as glass or transparent plastic such as polystyrene, acrelic resin, polyvinylchloride resin, and make it dull to hide an inner container used for pot plant 3 hid inside. The material used for an inner pot plant container 3 should be made from plastic materials because of its light weight and low production cost. The shape of pot plant/aquarium container is not limited, it could be cylindrical, spherical, ellipsoidal, or polygonal in design.

FIGS. 2 and 3 show cross sectional drawing and top-view drawing of the container for fish and pot plant 1 which absorbing water from an outer fish container 2 through a rope 4 inserted through a hole bored at the bottom side of an inner pot plant container 3 to give a moisture to pot plant grown above. The figure demonstrates an inner pot plant container 3 which can insert to fit into the top section of the fish aquarium part 2, with an opening 5 to let air circulation from outside above the water surface in the fish container 2. This opening is being used as fish feeding slot as well, or design an opening section from the top side by making an inner pot plant container 3 concave in shape to make an opening gap 6. There are many of tiny water drainage holes at the bottom of pot plant container 3. The container for fish and pot plant using a rope to absorb water is an appropriate design for a small-sized container.

FIGS. 4 and 5 show cross sectional drawing and top-view drawing of the container for fish and pot plant with an installation of a hand pump (the same model as found in the glass cleaning bottle or shampoo bottle) to suck out the water from the lower fish bowl section to feed on the soil used in pot plant grown above. An amount of water could be adjusted depending on requirement of each type of plant, for this function, an inner container for pot plant 3 is designed a concave opening 7 to install a hand pump 8 and suction tube 9.

FIG. 6 shows cross sectional drawing and top-view drawing of the container for fish and pot plant which utilize the small electric pump, and FIG. 7 shows a flow control valve and an end of the pipe. According to the figure, pump 10 pulls water from an outer fish container 2 through pipe 11 making water flows through an end of the pipe 12 by which the flow rate is controlled by valve 13. Water is filtered through layers of soil, sand, small pebbles, and synthetic filter sheet through lots of tiny holes at the bottom of pot plant container 3 back to fish container 2 another part of water is flowing through the end of pipe 14 back to an outer fish container 2 directly, which allows a control for an appropriate amount of water depends on a requirement for each type of plant.

FIG. 8 shows drawing of the container for fish and pot plant with wall mounting design, which consists of wall mounting instrument.

FIG. 9 demonstrates the metal sheet 15 attached to the back of outer fish container, in which the container can be attached or removed from a metal panel 16 attached to the wall with screws.

### BRIEF DESCRIPTION OF THE DRAWINGS

FIG. 1 shows the invention of the container which combined the function of pot plant container and fish container together.

FIG. 2 shows the cross-sectional view of the invention which use water-absorption technique.

FIG. 3 shows the top view of the invention which use water-absorption technique.

FIG. 4 shows the cross-sectional view of the invention which use hand-pump instrument.

FIG. 5 shows the top view of the invention which use hand-pump instrument.

FIG. 6 shows the top view of the invention which use a small electric pump.

FIG. 7 shows a magnified picture of control valve of the invention which use a small electric pump.

FIG. 8 shows a wall-type invention container.

FIG. 9 show the metal sheet attached to the back of outer fish container and the metal panel attached to the wall with screws.

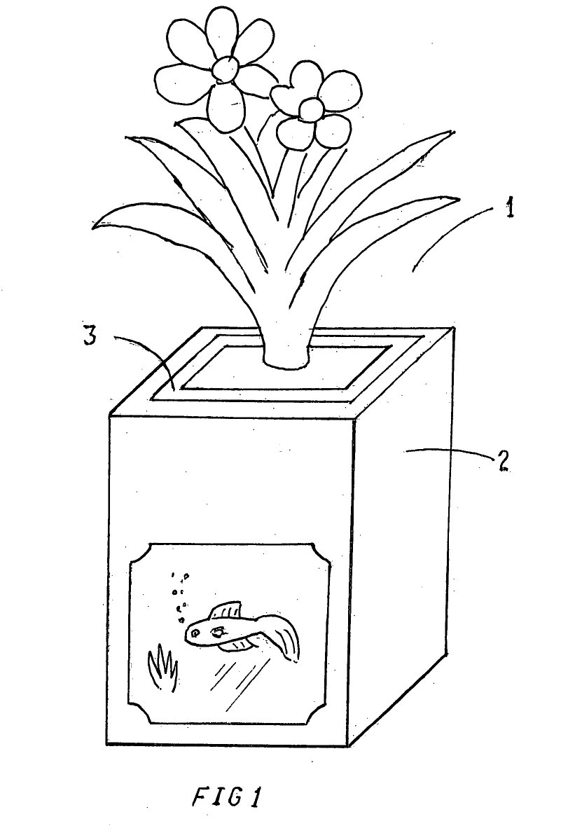

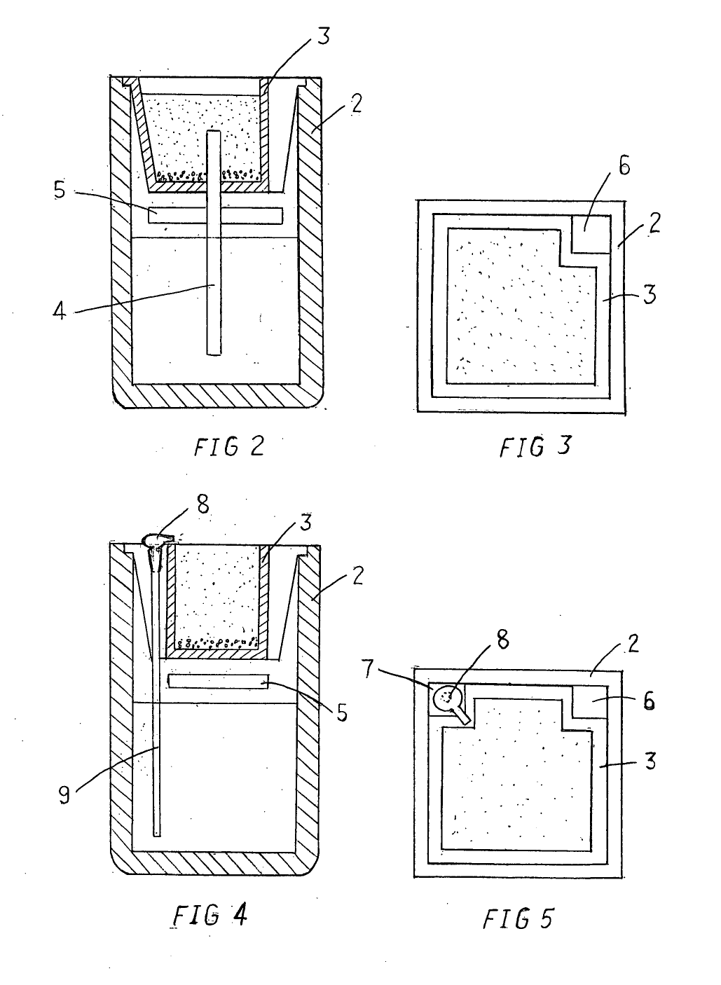

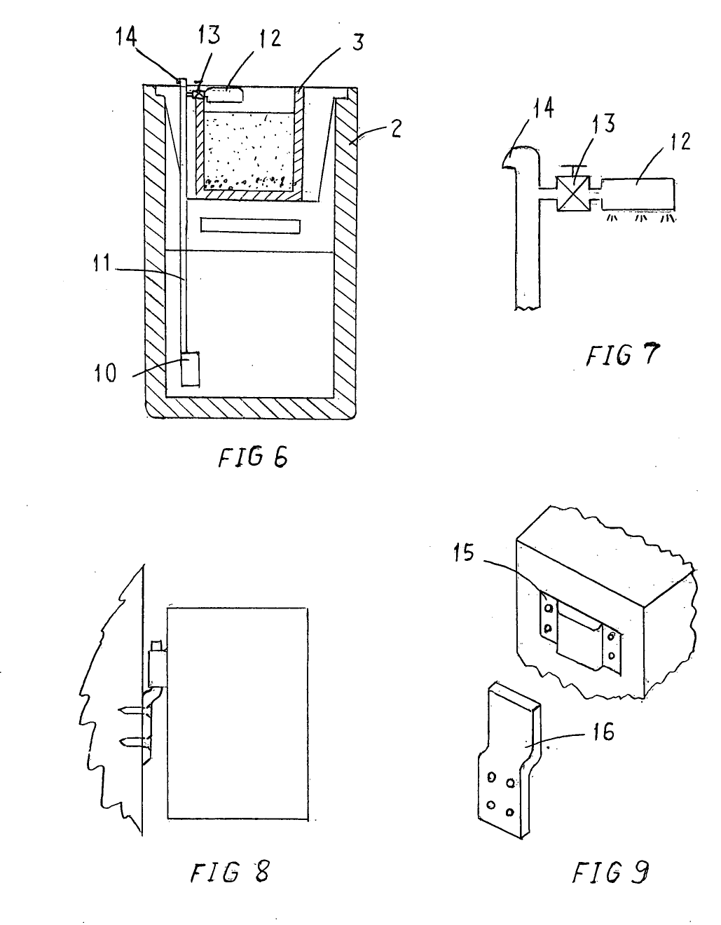

1. A container which combined the function of plant growing and fish keeping together, comprising:
a) The outer container component used for water containing for fish. There is at least one transparent side to allow a vision of fishes inside.
b) The inner container component for pot plant fitting hidden inside.
c) At least one opening at the back, side or top of the container to enable air circulation and use for fish feeding.

2. The container as in claim 1, further comprising a rope or moisture absorbent material for transmission for water from the outer fish container to the soil used in pot plant grown above.

3. The container as in claim 1, further comprising hand-pump instrument (the same model as found in the glass cleaning bottle or shampoo bottle) to suck water from the outer fish container to the inner pot plant container above.

4. The container as in claim 1, further comprising a small electric pump and a pipe to suck water from the outer fish container to the inner pot plant container above.

5. The container as in claim 4, wherein said small electric pump and pipe include a flow control valve to control the flow rate of water from a small electric pump to flow through an inner pot plant container or making all of water flows into an outer fish container section directly.

6. The container as in claim 1, further comprising wall-mounting instrument at the back of container for mounted on a wall.

7. The container as in claim 1, further comprising lighting equipment for illuminating interior portion of the outer fish container.

8. The container as in claim 1, wherein the inner container for pot plant has an artificial plant or flower in place of the real one.
